(19) United States
(12) Patent Application Publication
(10) Pub. No.: US 2020/0383758 A1
(43) Pub. Date: Dec. 10, 2020

(54) SYSTEMS AND METHODS FOR ANALYZING DENTAL IMPRESSIONS

(71) Applicant: SmileDirectClub LLC, Nashville, TN (US)

(72) Inventors: Christopher Yancey, Nashville, TN (US); Duane Daniel Hunter, Nashville, TN (US)

(21) Appl. No.: 16/678,359

(22) Filed: Nov. 8, 2019

Related U.S. Application Data
(60) Provisional application No. 62/856,958, filed on Jun. 4, 2019.

(51) Int. Cl. A61C 9/00

(52) U.S. Cl. CPC A61C 9/0053; A61C 9/0006

(57) ABSTRACT

A method for analyzing a dental impression including receiving, by a dental impression review computer system, an image of a first dental impression administered by a user of the user's teeth, analyzing, by the dental impression review computer system, the image of the first dental impression, and providing, by the dental impression review computer system, feedback to the user based on the analysis.

### CROSS-REFERENCE TO RELATED PATENT APPLICATIONS

This application claims the benefit of and priority to U.S. Provisional Patent Application No. 62/856,958, filed Jun. 4, 2019, which is incorporated herein by reference in its entirety.

### TECHNICAL FIELD

The present disclosure relates generally to analyzing dental impressions, and more particularly, to systems and methods for determining the acceptability of dental impressions for fabricating intraoral devices.

### BACKGROUND

A dental impression is a negative imprint of the teeth and tissues in the mouth. To create a dental impression, a dental tray having an impression material therein is fit over the dental arches of the patient, and then the impression material sets to a solid leaving an imprint of the structures in the mouth in the material. When removed from the mouth, the impression provides a detailed and stable negative of the teeth. The negative impression, or a digital scan of the negative impression, can be utilized to produce a physical or digital reproduction of the teeth, which can then be used to create intraoral devices, such as dental aligners, retainers, and dentures.

Dental impressions can be made in a dental office or by a patient using an at-home dental impression kit. Once completed, the dental office or patient provides the impressions to a manufacturer of intraoral devices. However, if the dental impressions are of poor quality or include any errors (e.g., incomplete impression of the teeth and tissues), the patient may be required to complete additional impressions, which is inconvenient and delays the patient from receiving the intraoral devices.

### SUMMARY

According to an example embodiment, a method for analyzing a dental impression includes receiving, by a dental impression review computer system, an image of a first dental impression administered by a user of the user's teeth, analyzing, by the dental impression review computer system, the image of the first dental impression, and providing, by the dental impression review computer system feedback based on the analyzing.

According to another example embodiment, a dental impression review computer system includes a processor and memory coupled to the processor, the memory storing instructions that, when executed by the processor, are configured to cause the processor to receive an image of a first dental impression administered by a user of the user's teeth, analyze the image of the first dental impression, and provide feedback to the user based on the analysis.

According to another example embodiment, a method for analyzing a dental impression includes receiving, by a dental impression review computer system, an image of a first dental impression from a mobile device associated with a user, the image of the first dental impression being of a dental impression administered by the user, analyzing, by the dental impression review computer system, the image of the first dental impression, identifying, by the dental impression review computer system, a deficiency with the first dental impression from the image based on the analysis, and providing, by the dental impression review computer system, feedback based on the deficiency to the mobile device associated with the user, the feedback indicating how the user can administer a second dental impression to reduce the likelihood of the second dental impression from including the deficiency.

Various other embodiments and aspects of the disclosure will become apparent based on the drawings and detailed description of the following disclosure.

### BRIEF DESCRIPTION OF THE DRAWINGS

FIG. 1 is a block diagram showing a system for fabricating dental aligners, according to an exemplary embodiment.

FIG. 2 is an illustration of a dental aligner fabricated using the system of FIG. 1, according to an exemplary embodiment.

FIG. 3 is a block diagram of a computing device for analyzing dental impressions, according to an exemplary embodiment.

FIG. 4 is a flow diagram of a method for analyzing acceptability of dental impressions to be used to fabricate dental aligners, according to an exemplary embodiment.

FIG. 5 is a flow diagram of a method for analyzing photographs of dental impressions to provide feedback in real-time or near real-time, according to an exemplary embodiment.

FIG. 6A is an illustration of a dental impression suitable for fabricating a dental aligner, according to an exemplary embodiment.

FIGS. 6B-6I are illustrations of dental impressions that contain a deficiency that may be unsuitable for fabricating a dental aligner, according to exemplary embodiments.

### DETAILED DESCRIPTION

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, described herein are systems and methods for analyzing dental impressions used for fabricating intraoral devices, such as dental aligners, retainers, and mouth guards. For example, in some embodiments, the dental impressions may be created at home by a patient using an at-home dental impression kit. In another example, the at-home dental impression kit can be provided directly to the patient via a mail service from an entity associated with the manufacture of dental aligners instead of from a dentist or orthodontist. In other embodiments, the impressions may be created at a dental office by a dental professional of the patient's mouth (e.g., a dental assistant, hygienist, dentist, orthodontist, or the like). According to various embodiments, a computing system or device receives and analyzes one or more dental impressions of a patient based on a 2D image of a dental impression or a 3D image (e.g., a 3D model) of teeth of the patient created from a dental impression, and determines whether the impression is acceptable for fabricating a suitable intraoral device for the patient. In some embodiments, an impression may be determined to be acceptable if the impression includes a complete or substantially complete representation of a dental arch (e.g., a mandibular arch or maxillary arch) of the patient. In some embodiments, a complete or substantially complete representation of a dental arch includes clear impressions of the shape, spacing, and geometry of each tooth in the dental arch (e.g., from a tip of the tooth to the gum line). In some embodiments, a complete or substantially complete representation of a dental arch may also include clear representations of a gingival line for the dental arch. In some embodiments, a suitable intraoral device is fabricated to fit comfortably in the patient's mouth over a corresponding dental arch (e.g., teeth on the patient's upper or lower jaw). In some embodiments, when the intraoral device is a dental aligner, a suitable dental aligner is fabricated to be further capable of repositioning at least one tooth in a corresponding dental arch of the patient according to a treatment plan.

For example, in some embodiments, the computing system can receive a photograph (e.g., 2D image or 3D image) of a dental impression from the patient or from the professional, and may analyze the photograph to determine whether the dental impression is acceptable for fabricating a suitable dental aligner for the patient. In another example, the computing system may receive or generate a 3D scan (e.g., 3D image or 3D model) of a dental impression, and may analyze the 3D scan to determine if the impression is acceptable for fabricating a suitable dental aligner for the patient. In various embodiments, the computing system or device may map the patient's dentition in an image (e.g., 2D image, 3D image, or 3D model) of the impression, and may analyze the mapping to identify deficiencies with the impression, for example, such as whether the impression is too shallow, whether the impression contains a distortion, whether the impression fails to capture the full dental arch of the patient, whether the impression fails to include at least a portion of the patient's gum anatomy (or gingiva), and/or the like. In some embodiments, the computing system or device may provide feedback to the patient to improve a subsequent impression based on any identified deficiencies in the analyzed image of the impression.

For example, in some embodiments, the computing system can receive an image (e.g., a 2D image, 3D image, or 3D model) of a first dental impression captured by the patient or the professional, analyze the first dental impression, and provide feedback to the patient or the professional prior to a second dental impression of the patient's teeth being taken. For example, in the case where the impression was taken by the patient using an at-home dental impression kit, the computing system or device may provide feedback (e.g., via a notification, alert, email, text message, video message, video chat, or the like) to the patient to provide one or more suggestions tailored to the identified deficiencies of the impression, such that the patient can improve the quality of one or more subsequent impressions. In some embodiments, the computing system or device may suggest, for example, to bite down on the dental tray with greater or lesser force, to ensure the dental tray is properly aligned with the teeth and dental arch, to avoid movement or adjustment after the dental tray is seated, to leave the tray in the mouth for a longer amount of time, to ensure that a putty mixture is mixed properly, to ensure that the putty mixture is distributed evenly around the dental tray, to ensure that a thermally active impression tray is heated to the proper temperature, and/or the like. Various examples of a dental impression kit and methods thereof are provided in U.S. Publication No. 2018/0368941, filed on Oct. 5, 2017, the disclosure of which is incorporated by reference herein in its entirety.

In various embodiments, the feedback can be provided in real-time or near real-time, or can be provided along with a subsequent impression kit (e.g., a retake kit). For example, in some embodiments, an impression kit may include redundant components that enable two impressions to be taken of the patient's mandibular arch and two impressions to be taken of the patient's maxillary arch. In other embodiments, the impression kit may include a set of thermally active impression trays (e.g., one or more for the mandibular arch and one or more for the maxillary arch), such that one or more impressions can be taken using the same tray simply by heating the tray to a particular temperature. In either case, in some embodiments, after an impression (e.g., a first impression) is taken, the patient (or someone helping the patient) may capture one or more views (e.g., 2D or 3D images) of the impression using a suitable imaging device (e.g., a camera, wand, or the like). The one or more views of the impression may be uploaded to the computing system (e.g., via a computer application, mobile application, Internet web site, email, text message, video streaming, or the like), and the computing system may analyze the one or more views to determine whether there are any deficiencies with the impression, and may provide the patient feedback (e.g., via a notification, alert, email, text message, video message, video chat, or the like) in real-time or near real-time regarding impression techniques that can improve subsequent impressions (e.g., a second impression). In some embodiments, the user can capture a plurality of images for each of the views of the one or more views of the impression. For example, for a first view of the one or more views, the user can capture one, two, three, or more images at the same or substantially same viewpoint, and the user can then select a best image to upload to the computing system or the user can upload multiple images to the computing system, including all of the images taken (e.g., one, two, three, or more images). Once the plurality of images of the view of the impression are uploaded to the computing system, the computing system may choose at least one of the plurality of images of the view to analyze (e.g., the computer system can analyze each uploaded image, a best image, a combination of two or more images). In some embodiments the computing system may direct the user to recapture at least one of the one or more views of the impression to upload to the computing system. For example, the computing system can determine that the images captured for a view are unsatisfactory or otherwise do not meet a minimum threshold requirement (e.g., brightness, scene captured, focus), and in response, prompt the user to capture one or more new images for the same view and other views. In some embodiments, the impression techniques may be tailored to the identified deficiencies in the one or more views of the impression, such that the patient can prevent similar deficiencies when taking a subsequent impression (e.g., the second impression), and prior to mailing, delivering, or otherwise returning the impressions to the manufacturer of intraoral devices. As used herein, “real-time” means at the same time impressions are being taken, simultaneously or near-simultaneously when data is received from the patient, or within a time period after receiving data from the patient (e.g., the same day, less than a week, less than five days, less than two days, less than twenty-four hours, less than twelve hours, less than eight hours, less than four hours, less than two hours, less than one hour, less than thirty minutes, less than fifteen minutes, less than ten minutes, less than five minutes, less than one minute, less than thirty seconds).

In some embodiments, the computing system may analyze an image (e.g., a 2D image, a 3D image, a 3D model, and or the like) of one or more impressions received from the patient or the dental professional. For example, in some embodiments, after the impressions are received from the patient or dental professional, one or more images (e.g., 2D images, 3D scans, or the like) may be captured from the received impressions, and the computing system may analyze the one or more images to determine whether the impressions are acceptable for fabricating a suitable dental aligner. In some embodiments, if the impressions are not acceptable, the computing system may cause a subsequent impression kit (e.g., a retake kit) to be sent, such that the patient can retake one or more impressions. In some embodiments, the subsequent impression kit may be a standard impression kit, or may be a partial impression kit that is tailored based on the identified deficiencies in the analyzed one or more images of the impression. In some embodiments, the computing system may also provide feedback regarding one or more impression techniques that are tailored to the identified deficiencies in the one or more images of the impression, such that the patient can prevent similar deficiencies when taking a subsequent impression (e.g., a second impression via the impression kit). In various embodiments, the feedback may be included in the subsequent impression kit (e.g., as an instruction sheet) and/or may be sent to the patient (e.g., via a notification, alert, email, text message, video message, video chat, or the like), such that the patient can prevent similar deficiencies when taking a subsequent impression (e.g., a second impression).

In some embodiments, the computing system or device may analyze deficient 3D scans (or 3D images) generated from the received impressions or from the received images of the impressions to determine whether the deficient 3D scans provide enough information to generate a suitable 3D model of the impressions that can be used to fabricate the dental aligner. For example, if the computing system or device determines that there is enough information (or geometry) in the deficient 3D models to generate the suitable 3D model of the impressions, the computing system or device may merge the information (e.g., portions of two or more of the 3D models) to generate the suitable 3D model. In this case, additional dental impressions for the patient (e.g., via a retake kit) may be avoided. These and other aspects and features of various embodiments of the present disclosure are discussed in more detail with reference to the figures.

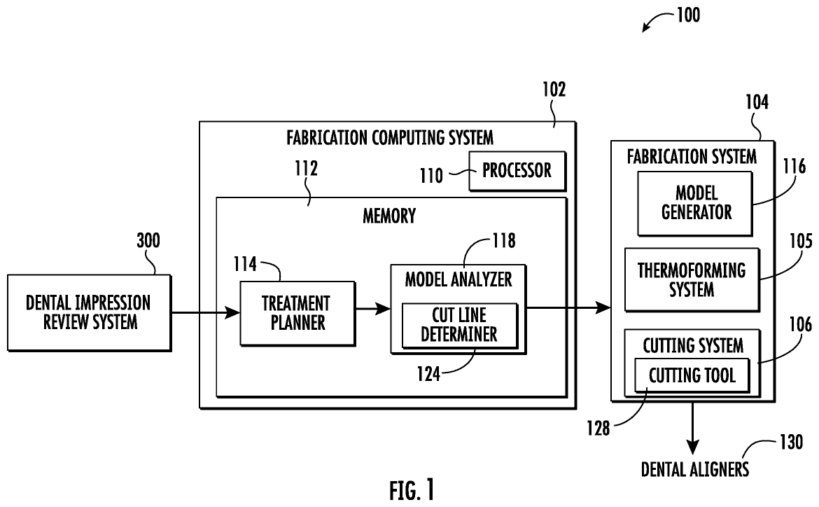

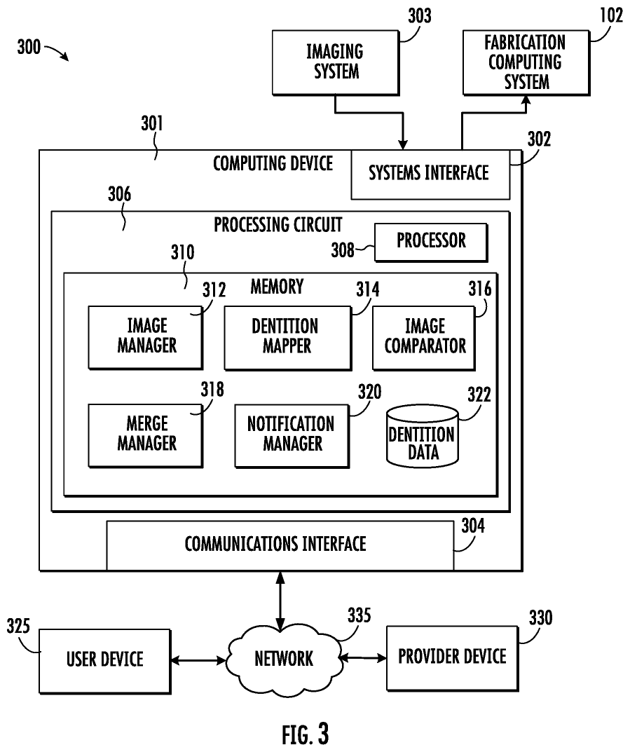

FIG. 1 illustrates an embodiment of a system 100 for fabricating dental aligners, accordingly to some embodiments, which may be useful for practicing embodiments described herein. The system 100 is shown to include a dental impression review system 300, a dental aligner fabrication computing system 102, and a fabrication system 104. In various embodiments, the dental impression review system 300 analyzes one or more images (e.g., 2D images, 3D images, 3D models, and/or the like) of dental impressions to determine whether the impressions are suitable for fabricating a dental aligner for the patient. In some embodiments, the dental impression review system 300 generates or identifies suitable 3D models of the impressions, and provides the suitable 3D models to the fabrication computing system 102 for fabricating one or more suitable dental aligners for the patient. In an illustrative embodiment, the 3D models may be embodied as STL files that describe the surface geometry of the corresponding dental impressions. However, the present disclosure is not limited thereto, and in other embodiments, the 3D models may be embodied as any suitable surface or solid 3D modeling (or imaging) data. Hereinafter, the models (e.g., 3D models) generated from the impressions may be referred to generally as dentition scans. An example embodiment of the dental impression review system 300 is shown in FIG. 3, and will be described in more detail with reference to FIG. 3.

In some implementations, the fabrication computing system 102 may be embodied as or include a processing circuit which includes a processor 110 and memory 112. The processor 110 may be a general purpose single-chip or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. The processor 110 may also be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The memory 112 (e.g., memory, memory unit, storage device) may include one or more devices (e.g., RAM, ROM, EPROM, EEPROM, optical disk storage, magnetic disk storage or other magnetic storage devices, flash memory, hard disk storage, or any other medium) for storing data and/or computer code for completing or facilitating the various processes, layers and circuits described in the present disclosure. The memory 112 may be or include volatile memory or non-volatile memory, and may include database components, object code components, script components, or any other type of information structure for supporting the various activities and information structures described in the present disclosure. According to an illustrative embodiment, the memory 112 is communicably connected to the processor 110 via a processing circuit and includes computer code for executing (e.g., by the processing circuit or the processor 110) the processes described herein.

The memory 112 may store various modules or be comprised of a system of circuits. The circuits may include hardware, memory, and/or other components configured or implemented to execute various functions. As shown in FIG. 1, in some embodiments, the memory 112 may include (or store) a treatment planner 114 and a model analyzer 118. The treatment planner 114 may be a circuit designed or implemented to perform various functions corresponding to generating a treatment plan for the patient's dentition (e.g., based on the dentition scans 108).

In various embodiments, the treatment planner 114 is configured to produce, generate, assemble, compile, or otherwise create a treatment plan for moving various teeth of a patient's dentition. The treatment plan may be a series of movements for teeth of a patient's dentition from a starting arrangement to an ending arrangement. The treatment plan may be generated by or through use of the treatment planner 114. In some embodiments, a dental technician or professional uses the treatment planner 114 to generate the treatment plan by manipulating individual teeth or groups of teeth shown in the dentition scans. For instance, the treatment planner 114 may present the dentition scans (e.g., received from the dental impression review system 300 or other suitable imaging or scanning system) to the dental professional, who can then manipulate various teeth within the dentition scans.

The treatment planner 114 is configured to generate various stages of the treatment plan to move the teeth from the starting position (e.g., their current position as represented within the dentition scan) to a final position selected or provided by the dental professional. In some embodiments, the treatment planner 114 is configured to create the treatment plan without the assistance of a dental professional. For instance, the treatment planner 114 may analyze the dentition scans to align the teeth with a dental arch fitted to the teeth. The treatment planner 114 may then generate various stages of the treatment plan to move the teeth from the starting position to the final position.

The fabrication system 104 may include various systems for fabricating a dental aligner. As shown in FIG. 1, in some embodiments, the fabrication system 104 may include a model generator 116, a thermoforming system 105, and a cutting system 106. The model generator, 116 may be configured to generate a model based on the generated treatment plan. The model may be a three dimensional representation of the patient's dentition at various intervals (e.g., at the start of the treatment plan and at various intervals throughout the treatment plan, each step of the treatment plan, select steps of the treatment plan, every third step of the treatment plan). The model analyzer 118 may be configured to analyze the models generated via the model generator 116 for fabrication dental aligners 130.

The model generator 116 is configured to generate models of the patient's dentition at the various stages of the treatment plan generated by or using the treatment planner 114. The model generator 116 generates a plurality of models including an initial model, a final model, and at least one intermediate model. The initial model corresponds to a first stage of the treatment plan. The final model corresponds to a final stage of the treatment plan. Each intermediate model corresponds to an intermediate stage of the treatment plan. In some embodiments, the models generated by the model generator 116 may be physical 3D models of the patient's dentition at the various stages of the treatment plan. For example, in some embodiments, the model generator 116 may include (or communicably coupled to) a 3D printer to print the physical 3D models. However, the present disclosure is not limited thereto, and in other embodiments, the model generator 116 may generate the physical 3D models using any suitable methods or devices, for example, such as sculpting, pressing, casting, molding, or the like.

In various examples, the patient is provided a dental aligner 130 to be worn at each stage of the treatment plan for a predetermined duration (e.g., one week, two weeks, one month). The dental aligners 130 are constructed from a material thermoformed (e.g., via a thermoforming system 105) to a physical model (e.g., as generated by the model generator 116) and are worn in the patient's mouth (e.g., over the patient's teeth). The dental aligners 130 apply a force on at least one of the patient's teeth to move at least one tooth according to the treatment plan.

In some embodiments, at least one stage (e.g., an initial stage) or each stage of the treatment plan includes more than one dental aligner 130 having the same shape but having a different thickness or being constructed of a different material (e.g., a harder or softer material). For example, the treatment plan can specify that the patient wears the softest dental aligner in a first sub-stage, followed by a dental aligner of medium hardness, followed by the hardest dental aligner. In this way, the patient can be acclimated to the dental aligner 130 for the at least one stage or for each of the stages of the treatment plan, by starting with the softer dental aligner and working up to the hardest dental aligner. However, the present disclosure is not limited thereto, and in other embodiments, the patient may be provided with only one dental aligner 130 for each stage of the treatment plan.

In some embodiments, during fabrication of the dental aligners 130, the material thermoformed to the model (e.g., via the thermoforming system 105) is trimmed, such that the fabricated dental aligner 140 can fit comfortably within the patient's mouth. In some embodiments, the dental aligners 130 are trimmed to include representations of the patient's teeth and a portion of the patient's gingiva (or gums). As described in greater detail below, the model analyzer 118 is configured to determine a cut line for the dental aligners 130 and the model analyzer 118 is configured to control the cutting system 106 to cut the dental aligners 130 along the cut line.

For example, in some embodiments, the model analyzer 118 may be configured to identify the teeth and gingiva (e.g., gum) portions of the model of the patient's dentition generated via the model generator 116. For example, the teeth portion of the model corresponds to the teeth of the patient's dentition, and the gingiva portion of the model corresponds to a portion of the gingiva of the patient's dentition. In some embodiments, the model analyzer 118 may be configured to identify the teeth portion within the model using a teeth identification algorithm. The teeth identification algorithm may identify various characteristics within the model which are consistent with the teeth portion, such as surface contours of crowns, separation or gaps in the interproximal region (e.g., the space between the teeth portion), and/or the like. In some embodiments, the model analyzer 118 may be configured to identify the teeth portion within the model, and other portions of the model that are not identified as the teeth portion may be identified as the gingiva portion of the model. In some embodiments, the model analyzer 118 may be configured to generate an object (OBJ) file including each of the teeth and gingiva portions, with each of the teeth and gingiva portions being represented as separate objects within the OBJ file.

In some embodiments, the model analyzer 118 is configured to identify a gingival line for the model of the patient's dentition. The gingival line may be defined as the juncture or interface between the teeth portion and the gingiva portion of the model. In some embodiments, the model analyzer 118 may be configured to identify the gingival line by identifying a location where the teeth portion and gingiva portion of the model meet. As described above, the model analyzer 118 may be configured to identify a location of the teeth portion within the model, and may identify the location of the gingiva portion as the remaining portions of the model that are not identified as the teeth portion. Similarly, the model analyzer 118 may identify the gingival line based on where the portions of the model identified as the teeth portion meet portions of the model (e.g., the remaining portions) identified as the gingiva portion.

In some embodiments, the model analyzer includes a cut line determiner 124. The cut line determiner 124 is configured to define a cut line for the dental aligner 130. The cut line is a line or path which extends around the model of the patient's dentition and defines a travel path for a cutting tool 128 of the cutting system 106. The cut line determiner 124 (or a cutting system controller) may control the cutting tool 128 (e.g., various actuators which manipulate or otherwise move the cutting tool 128) to move along the cut line to cut the dental aligner 130 from the model (e.g., from the physical model). In other embodiments, the cut line determiner 124 (or the cutting system controller) may move the model (with the dental aligner 130 positioned thereon) relative to the cutting tool 128 such that the cutting tool 128 can cut the dental aligner 130 from the model along the cut line.

In some embodiments, each component of the system 100 (e.g. the dental impression review system 200, the fabrication computing system 102, or the fabrication system 104) is contained by a single business entity in a single location (e.g. a building, a group of buildings). In other embodiments, each component of the system 100 is contained by a single business entity, and at least part of a first component of the system 100 (e.g. the model analyzer 118) is contained within a separate location (e.g. one of two different buildings) from a second component of the system 100 (e.g. the model generator 116). In further embodiments, at least a part of a first component of the system 100 is contained by a first business entity, and at least a part of a second component of the system 100 is contained by a second business entity.

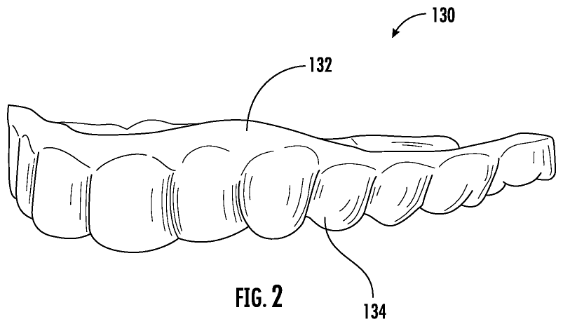

Accordingly, referring to FIG. 2, a dental aligner 130 fabricated using the system 100 of FIG. 1 is shown, according to some embodiments. In some embodiments, the dental aligner 130 is fabricated and cut (e.g., along the cut line) to fit comfortably within the patient's mouth. In some embodiments, the dental aligner 130 is configured to cover the patient's teeth and a portion of the patient's gingiva. Thus, as shown in FIG. 2, the resulting dental liner 130 includes a gingiva portion 132 corresponding to the portion of the patient's gingiva, and teeth portion 134 corresponding to the patient's teeth.

Referring now to FIG. 3, an illustrative dental impression review system 300 for analyzing dental impressions is shown, according to some embodiments. As discussed above, in some embodiments, the main input to the treatment planner 114 is the dentition scans (e.g., the 3D models of the dental impressions). Thus, if the dentition scans are insufficient, the resulting intraoral device fabricated using the dentition scans may not fit the patient properly. According to various embodiments, the dental impression review system 300 may analyze one or more images (e.g., 2D images, 3D images, 3D models, or the like) of the dental impressions that are used to generate the dentition scans to determine whether the impressions are an acceptable representation of the patient's dentition for fabricating the dental aligner 130. In some embodiments, the one or more dental impressions may be created by a patient with an at-home dental impression kit. In other embodiments, the one or more dental impressions may be created by a dental professional in a dental office. Still in other embodiments, the one or more dental impressions may be direct scans of the patient's dentition captured at home using a suitable imaging device (e.g., a stereoscopic wand or other imaging device), at a remote scan (or imaging) center, or the like.

In various embodiments, the dental impression review system 300 may utilize computer vision with machine learning to analyze the images of the impressions. For example, in some embodiments, the dental impression review system 300 may be provided training data to distinguish between good impressions and bad impressions. In some embodiments, the dental impression review system 300 may be trained to identify anomalous portions in the analyzed images of the dental impressions, and may determine whether there is enough information to merge two or more 3D models of the dental impressions to generate a suitable 3D model (e.g., dentition scan) of the impression. In some embodiments, the dental impression review system 300 may analyze one or more uploaded images (e.g., 2D or 3D views) of impressions taken by the patient, and may provide one or more suggestions for improved techniques based on the images in real-time or near real-time.

In use, as described further below, the dental impression review system 300 acquires or generates an image (e.g., a 2D image, a 3D image, a 3D model, or the like) of the patient's dentition from a dental impression, and maps the patient's dentition in the image to determine whether the impression is acceptable for fabricating a suitable intraoral device for the patient, such as the dental aligner 130 shown in FIG. 2. In some embodiments, if the impression is not acceptable, the dental impression review system 300 may provide a notification to the patient or dental professional with suggestions for improving an impression technique when creating subsequent dental impressions. In some embodiments, if the impression is not acceptable, the dental impression review system 300 may determine whether a suitable 3D model of the impression can be generated from 3D models of two or more impressions, for example, by merging the 3D models. In some embodiments, if the suitable 3D model of the impression cannot be generated, the dental impression review system 300 may cause a subsequent impression kit to be sent to the patient such that subsequent impressions can be taken. In some embodiments, the dental impression review system may provide feedback along with the subsequent impression kit for improving an impression technique when creating subsequent dental impressions.

Accordingly, in the illustrative embodiment shown in FIG. 3, the dental impression review system 300 is shown to include a computing device 301 that is communicably coupled to an imaging system 303, the fabrication computing system 102 (e.g., as shown in FIG. 1), a user device 325 associated with the patient, and a provider device 330 associated with a dental professional. In some embodiments, the imaging system 303 may generate the dentition scans from impressions received from the patient or the dental professional. For example, in some embodiments, after the impressions are returned to the manufacturer of the intraoral devices, the imaging system 303 may scan the impressions to generate the dentition scans. Accordingly, the imaging system 303 may include any suitable scanning or imaging device to scan a received impression to generate the dentition scan (e.g., 3D model) from the received impression. In an illustrative embodiment, the dentition scans may be embodied as STL files that describe the surface geometry of the corresponding dental impressions. However, the present disclosure is not limited thereto, and in other embodiments, the dentition scans may be embodied as any suitable surface or solid 3D modeling (or imaging) data. In some embodiments, the imaging system 303 may provide the generated dentition scans to the computing device 301 to analyze the dentition scans and to determine whether the dentition scans are acceptable for fabricating a suitable intraoral device for the patient. In some embodiments, the computing device 301 may generate a suitable 3D model (e.g., a suitable dentition scan) by merging two or more of the dentition scans received from the imaging system 303. In some embodiments, the computing device 301 may provide suitable dentition scans (e.g., received or generated) to the fabrication computing system 102 for fabricating the dental aligners based on the suitable dentitions scans, or may provide the suitable dentition scans back to the imaging system 303, such that the imaging system 303 can provide the suitable dentitions scans (or desired ones of the suitable dentitions scans) to the fabrication computing system 102 to fabricate corresponding dental aligners.

Before describing the computing device 301 in more detail, it should be noted that the components of the computing device 301 can be integrated within a single device or distributed across multiple separate systems or devices. For example, in various embodiments, the computing device 301 may be embodied as any suitable type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. In other embodiments, some or all of the components of the computing device 301 can be implemented as part of a cloud-based computing system. For example, in some embodiments, the computing device 301 may be embodied as a “virtual server” formed from multiple computing devices distributed across a network and operating in a public or private cloud. In still other embodiments, some or all of the components of the computing device 301 can be components of the fabrication computing system 102. In yet other embodiments, some or all of the components of the computing device 301 may be distributed across various components of the fabrication computing system 102, for example, such as part of the treatment planner 114 and part of the model generator 116. Accordingly, although the computing device 301 is illustrated in FIG. 3 as embodied in a single server computing device, it should be appreciated that the computing device 301 may be embodied in multiple devices cooperating together to facilitate the functionalities described herein.

As shown in FIG. 3, the computing device 301 illustratively includes a systems interface 302, a communications interface 304, and a processing circuit 306 including a processor 308 and memory 310. In other embodiments, the computing device 301 may include other or additional components and devices commonly found in a server computer or similar computing device, such as, for example, various input/output devices. In various embodiments, the systems interface 302 and the communications interface 304 may each include wired or wireless communications interfaces (e.g., jacks, antennas, transmitters, receivers, transceivers, wire terminals, etc.) for conducting data communications with imaging system 303, fabrication computing system 102, the user device 325, the provider device 330, and/or other internal or external systems or devices. In various embodiments, communications conducted via the systems interface 302 and the communications interface 304 can be direct (e.g., local wired or wireless communications) or via a network 335 (e.g., a WAN, the Internet, a cellular network, etc.).

In some embodiments, the systems interface 302 facilitates communications between the computing device 301 and the imaging system 303. For example, in some embodiments, computing device 301 may receive dentition scans of dental impressions (e.g., 3D models of the impressions) from the imaging system 303 via systems interface 302, and may analyze the dental impression scans for acceptability. In some embodiments, the systems interface 302 further facilitates communications between the computing device 301 and the fabrication computing system 102, and/or other components and systems of the system 100. In some embodiments, computing device 301 may provide acceptable dentition scans (e.g., 3D models of the impressions) to the fabrication computing system 102 (or to the imaging system 303) via the systems interface 302.

In some embodiments, communications interface 304 can facilitate communications between the computing device 301 and external applications and devices (e.g., user device 325, provider device 330, and/or the like) for enabling communications with the external applications and devices. For example, in some embodiments, the computing device 301 may receive one or more images (e.g., 2D images or 3D images) of a dental impression from the patient (e.g., via the user device 325) or from a dental professional (e.g., via the provider device 330) via the communications interface, and may provide feedback (e.g., via a notification, alert, email, text message, video message, video chat, or the like) to the patient (e.g., via the user device 325) and/or to the dental professional (e.g., via the provider device 330) via the communications interface 304. In some embodiments, the computing device 301 may receive dentition data (e.g., direct dentition photos, dental records, dental history, or the like) from the patient (e.g., via the user device 325) or from a dental professional (e.g., via the provider device 330) via the communications interface 304. While FIG. 3 shows the systems interface 302 and the communications interface 304 as being separate interfaces, the present disclosure is not limited thereto, and in other embodiments, the systems interface 302 and the communications interface 304 may be logical portions of the same interface.

In some embodiments, the processor 308 may be embodied as any suitable type of processor capable of performing the functions described herein. The processor 308 may be embodied as a single-core or multi-core processor(s), digital signal processor, microcontroller, or other processor or processing/controlling circuit. The processor 308 can be a general purpose or specific purpose processor, an application specific integrated circuit (ASIC), one or more field programmable gate arrays (FPGAs), a group of processing components, or other suitable processing components. The processor 308 is configured to execute computer code or instructions stored in memory or received from other computer readable media (e.g., CDROM, network storage, a remote server, etc.).

Memory 310 may be embodied as any suitable type of volatile or non-volatile memory or data storage capable of performing the functions described herein. In operation, the memory 310 may store various data and software used during operation of the computing device 301, such as operating systems, applications, programs, libraries, and drivers. In various embodiments, memory 310 can include one or more devices (e.g., memory units, memory devices, storage devices, etc.) for storing data and/or computer code for completing and/or facilitating the various processes described in the present disclosure. Memory 310 can include random access memory (RAM), read-only memory (ROM), hard drive storage, temporary storage, non-volatile memory, flash memory, optical memory, or any other suitable memory for storing software objects and/or computer instructions. Memory 310 can include database components, object code components, script components, or any other type of information structure for supporting the various activities and information structures described in the present disclosure. Memory 310 may be communicably connected to the processor 308 via the processing circuit 306, and may include computer code for executing (e.g., by processor 308) one or more processes described herein.

Still referring to FIG. 3, in an illustrative embodiment, memory 310 includes an image manager 312, a dentition mapper 314, an image comparator 316, a merge manager 318, a notification manager 320, and storage 322 for storing the dentition data of the patient. In some embodiments, the image manager 312 processes various images (e.g., 2D images, 3D images, 3D models, or the like) of one or more dental impressions received from the patient via the user device 325, the dental professional via the provider device 330, and/or the imaging system 303. For example, in some embodiments, the image manager 312 may process the received images to identify a corresponding patient associated with the received images, corresponding dental arches of the impressions shown in the images, corresponding views of the dental impression shown in the images, corresponding 3D models of the dental impression shown in the images, and/or the like. In some embodiments, the image manager 312 may associate available data regarding the patient's dentition with the images for a corresponding dental impression of the patient, such that related data corresponding to the patient's dentition can be used to determine whether the impressions are acceptable when analyzing the images, or whether an acceptable 3D model of the impressions (e.g., an acceptable dentition scan) can be generated from the available data. For example, in some embodiments, the image manger 312 may associate one or more direct views of a patient's dentition (e.g., stored in storage 322) that were previously received from the patient (or the dental professional) with a 3D model of a corresponding dental impression later generated by the imaging system 303 when the corresponding dental impression is received from the patient. In this case, for example, the direct views of the patient's dentition may be used to determine or estimate sizes of the patient's teeth, missing teeth, or the like, which can then be used to determine whether the geometries, contours, and shapes of the teeth shown in the corresponding 3D model have been correctly captured in the corresponding dental impression. Accordingly, in some embodiments, various related data regarding the patient's dentition may be used to heuristically determine (e.g., via machine learning, data mining, and/or the like) whether the impressions are acceptable, or whether a suitable 3D model of the impressions can be generated from the available data.

In some embodiments, the dentition mapper 314 may map various features of the patient's dentition in each of the received images (e.g., 2D images, 3D images, 3D models, or the like). In some embodiments, the dentition mapper 314 may identify the teeth and gingiva (e.g., gum) portions of the images using any suitable identification algorithm. For example, in some embodiments, the dentition mapper 314 may identify various characteristics within the images which are consistent with the teeth portion, such as surface contours of crowns, separation or gaps in the interproximal region (e.g., the space between the teeth portion), and/or the like. In some embodiments, other portions of the 3D models that are not identified as the teeth portion may be identified as the gingiva portion. In some embodiments, the dentition mapper 314 may map various contours, shapes, and features of the patient's dentition in each of the images. For example, in various embodiments, the dentition mapper 314 may map the size (e.g., from tip to gum line and/or width) of each tooth or each key teeth, gum portions, missing teeth portions, partial tooth impressions, gingival line portions, and/or the like, in each of the images.

In some embodiments, the dentition mapper 314 may identify one or more anomalous or incomplete portions in the mapping of each of the images (e.g., 2D images, 3D images, 3D models, or the like) indicative of an incomplete anatomy of the patient's dental arch. For example, in some embodiments, due to incorrect use by a patient, a dental professional, or other factors, a dental impression may not include clear impressions of one or more teeth or other areas of a dental arch. In this case, the dentition mapper 314 may include or use a suitable image recognition algorithm to identify the anomalous or incomplete portions (e.g., incomplete sides, teeth, or other parts of the impression) of the patient's dental arch in a corresponding image, or may be provided with quality review data from a technician indicative of whether the corresponding image includes an incomplete impression of the patient's dental arch. For example, the dentition mapper 314 may compare various mappings in the patient's dentition with average mappings of other people's dentitions. For example, in some embodiments, the dentition mapper 314 may compare the sizes of key teeth shown in the images with a range of sizes for like individuals (e.g., same sex, age, or the like). In this case, if the size of a key tooth in the image falls outside the range of an average like individual (e.g., exceeds or falls below a threshold), then that tooth portion in the image may be identified as a potential anomalous portion. In another example, the dental impression may not indicate a gingival line (e.g., where the teeth meet the gums) or may include only partial impressions of the gingival line (e.g., some portions of the impression that clearly indicate the gingival line while other portions do not indicate the gingival line). For example, a clear impression of the gingival line may not be captured if the patient does not bite down on the dental tray. In this example, the dentition mapper 314 may determine from the mapping of the corresponding image that the corresponding impression represents an incomplete anatomy based on the lack of the gingival line or inconsistent gingival line portions. However, the present disclosure is not limited to the non-limiting examples provided herein, and in other embodiments, other contours, features, sizes, geometries, and/or the like can be used to identify the anomalous portions.

In some embodiments, if the images analyzed by the dentition mapper 314 are images of the dental impression captured while taking the dental impressions (e.g., using an at-home dental impression kit), the dentition mapper 314 may provide any identified deficiencies in the images to the notification manager 320, such that feedback based on the identified deficiencies can be provided to the patient or dental professional in real-time or near real-time prior to taking a subsequent dental impression. For example, as discussed above, in some embodiments, the patient may be instructed to capture various views of a first impression taken with the in-home dental impression kit, and to upload the various views prior to taking subsequent impressions (or prior to mailing, delivering, or otherwise returning the impressions), such that potential deficiencies can be identified and one or more suggestions for improving the subsequent impression based on the identified deficiencies can be provided. In this case, in some embodiments, the dentition mapper 314 can determine from one or more views whether the first impression was taken properly. In some embodiments, the notification manager 320 can provide in real-time or near real-time feedback with suggestions for improved impression techniques based on any identified deficiencies in the various views. For example, in some embodiments, the notification manager 320 may provide the feedback via a notification, alert, email, text message, video message, video chat, or the like, such that the patient can use an improved impression technique to take a second impression using the same at-home impression kit. In some embodiments, the first impression is a first impression that the user takes during the impression process, and the second impression is the next subsequent impression that the user takes. In other embodiments the first impression is a subsequent impression (e.g. the second, third, fourth, or subsequent impression) taken during the impression process and the second impression is the next subsequent impression after the first impression. Accordingly, in some embodiments, the potential issues with impressions taken using an at-home impression kit can be reduced or minimized, such that subsequent impression kits (e.g., retake kits) can be avoided. In some embodiments, the suggestion provides instructions on how the user can administer a second or subsequent dental impression to eliminate or reduce the likelihood of the second dental impression from including an identified deficiency, or from including any type of known or unknown deficiency.

In other embodiments, if the images analyzed by the dentition mapper 314 are dentition scans (e.g., 3D models of the impressions) provided by the imaging system 303, then the image comparator 316 may compare the mappings of two corresponding models (or dentition scans) to determine if the models have overlapping anomalous portions. For example, in some embodiments, the imaging system 303 may generate a plurality of 3D models (e.g., dentition scans) based on different dental impressions for the patient. For example, in some embodiments, various sets of impressions may be taken for the patient (e.g., via a redundancy impression kit, a retake impression kit, or the like). In this case, two sets of impressions may be taken for the patient, two impressions for the patient's mandibular arch (i.e., the lower teeth) and two impressions for the patient's maxillary arch (i.e., the upper teeth). In this case, the imaging system 303 may generate a different model for each impression, such that four models are generated (e.g., two for the mandibular arch and two for the maxillary arch). In some embodiments, if the dentition mapper 314 determines that each of the models for a corresponding dental arch includes one or more anomalous portions, then the image comparator 316 may compare the anomalous portions for each of the corresponding models to determine if there is enough information (or geometry) in the models collectively to generate a suitable 3D model by merging the models.

For example, the image comparator 316 may compare two or more models corresponding to the impressions of the mandibular arch (or the impressions of the maxillary arch) with each other to determine if the anomalous portions of each of the models overlap with each other. In some embodiments, overlapping anomalous portions in two or more corresponding models may indicate that the two or more corresponding impressions are not suitable candidates to be merged for generating a full impression. In some embodiments, if none of the anomalous portions of at least two of the two or more corresponding models overlap, then this may indicate that the two corresponding models may be suitable candidates to be merged to generate the full impression. For example, if one impression of the mandibular arch indicates an anomalous portion on the right side of the lower teeth but has a clear impression of the left side of the lower teeth, and another impression of the mandibular arch indicates an anomalous portion on the left side of the lower teeth but has a clear impression on the right side of the lower teeth, the two models of the impressions may be merged to generate a suitable full impression of the mandibular arch.

Accordingly, in some embodiments, if the comparison indicates that the models of the two impressions are suitable candidates to be merged, the merge manager 318 may merge the models of the two impressions to generate a merged model of the impressions. In some embodiments, the merged manager 318 may be similar to or the same as the merge manager 208 described in U.S. patent application Ser. No. 16/548,712, filed on Aug. 22, 2019, the disclosure of which is incorporated by reference herein in its entirety. For example, in some embodiments, the merge manager 318 may merge the two models of the impressions using one or more merge strategies. In some embodiments, the merge manager 318 may be configured to align geometry of the models based on a common point or other common location. The merge manager 318 is configured to select geometry from either of the models using the merge strategy. In some embodiments, the merge manager 318 is configured to replace geometry in one model with selected geometry from another model. The selected geometry is associated with a common anatomical location in the patient's dental arch. In some embodiments, selecting the geometry using the merge strategy may include, for example, determining which of the dental impressions associated with the models includes more detail associated with the common anatomical location and/or determining which of the models includes greater depth associated with the common anatomical location. Thus, after merging, the merged model may include geometry from each of the two models of the impressions. In some embodiments, the merge manager 318 may be further configured to clean the merged model to generate a closed surface, for example, by performing Poisson surface reconstruction or by performing a gap closing algorithm.

In some embodiments, if the comparison indicates that the two impressions are not suitable candidates to be merged, then the notification manager 320 may generate a notification (or feedback) including a suggested impression technique, and may transmit the notification to the patient (e.g., via the user device 325). In some embodiments, the suggested impression technique may be tailored based on the deficiencies identified in the analyzed impressions. For example, based on the mapping of the corresponding model, the dentition mapper 314 may determine that the gingival line was not properly captured. In this case, the suggested impression technique may be to press down on the dental tray such that a deeper impression including a portion of the patient's gums can be captured. In another example, based on the mapping of the corresponding model, the dentition mapper 314 may determine that a left side of the patient's teeth was not properly set in the impression. In this case, the suggested impression technique may be to provide equal pressure on both sides of the dental tray. Accordingly, in some embodiments, the notification manager 320 may identify a suitable impression technique that is likely to result in improved impressions based on the identified deficiencies of the analyzed impressions.

In some embodiments, the notification manager 320 may cause a retake impression kit to be sent to the patient in response to the comparison indicating that the two impressions are not suitable candidates to be merged. For example, in some embodiments, the patient may be notified that the retake impression kit is being sent along with the suggested impression technique to generate the improved impressions. In some embodiments, the content of the retake impression kit may be tailored based on the identified deficiencies of the analyzed impressions. For example, in some embodiments, if the dentition mapper 314 determines that there are issues with only the mandibular arch impressions, then the retake impression kit may include only an impression kit for the mandibular arch, while excluding an impression kit for the maxillary arch. Similarly, in another example, if the dentition mapper 314 determines that there are issues with only a right side of the maxillary arch impressions, then the retake impression kit may include only a partial impression kit for the right side of the maxillary arch, and may exclude impression kits for other portions of the patient's dentition. Accordingly, the costs associated with retake impression kits may be reduced. However, the present disclosure is not limited thereto, and in other embodiments, a standard retake kit may be sent to the patient, or the patient may be directed to schedule an appointment at a remote scanning (or imaging) center.

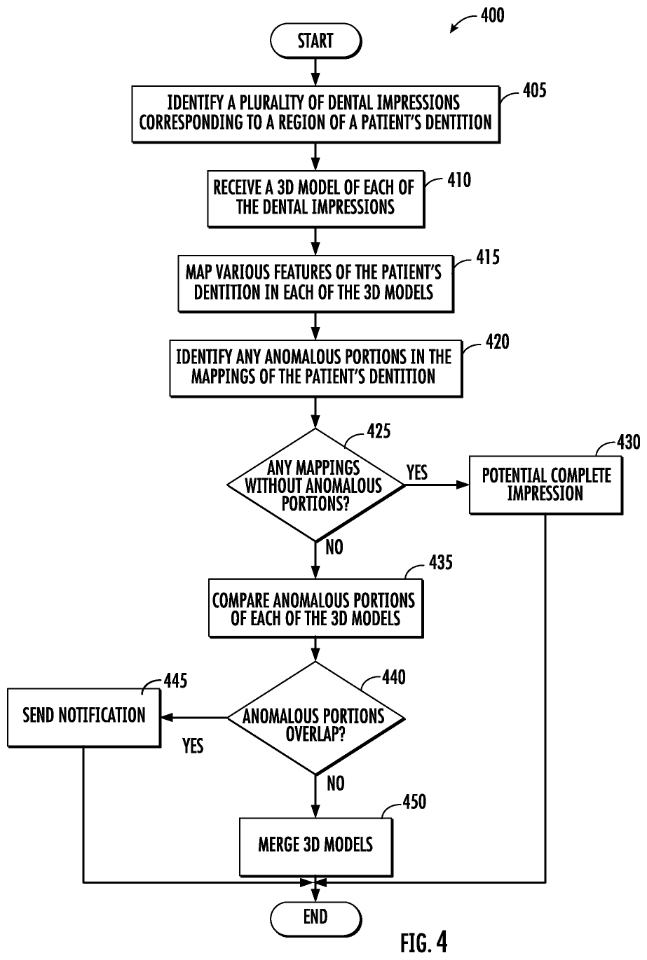

FIG. 4 is flow diagram of a method for analyzing acceptability of dental impressions used to fabricate dental aligners, according to some embodiments. The functionalities of the method 400 may be implemented using, or performed by, the components detailed herein in connection with FIGS. 1 and 3. In brief overview, the method 400 of FIG. 4 may be used, for example, to analyze acceptability of dentition scans (or 3D models) used to fabricate intraoral devices, such as the dental aligner 130 shown in FIG. 2.

Referring to FIG. 4, the method 400 starts, and at operation 405, a plurality of dental impressions corresponding to a region of a patient's dentition are identified. For example, as described above, in some embodiments, the dental impressions may be taken by the patient using an at-home dental impression kit. In some embodiments, the at-home dental impression kit may include a main dental impression kit to capture impressions of a mandibular arch region of the patient's dentition and a maxillary arch region of the patient's dentition. In some embodiments, the at-home dental impression kit may include a redundant impression kit to capture redundant impressions of the mandibular arch region of the patient's dentition and the maxillary arch region of the patient's dentition. In some embodiments, the plurality of dental impressions may include at least some of the impressions from the main impression kit and the redundant impression kit. In some embodiments, the plurality of dental impressions may also include impressions taken from a retake impression kit, if available. Accordingly, in some embodiments, the plurality of dental impressions may include at least two dental impressions of at least one region of the patient's dentition (e.g., the mandibular arch region and/or the maxillary arch region).

At operation 410, a 3D model (e.g., dentition scan) is received (or generated) for each of the impressions identified in operation 405. For example, in some embodiments, the image manager 312 may receive the 3D model for each of the impressions from the imaging system 303. In other embodiments, the image manager 312 may generate the 3D model for each received impression. In various embodiments, each of the 3D models may be embodied as a three-dimensional representation of the geometry of a corresponding dental impression, which is in turn a negative representation of a corresponding dental arch (e.g., a mandibular arch or maxillary arch) of the patient.

At operation 415, various features of the patient's dentition is mapped in each of the 3D models. For example, in some embodiments, the dentition mapper 314 may identify the teeth and gingiva (e.g., gum) portions in each of the 3D models using any suitable identification algorithm. In various embodiments, the mapping of the 3D models may enable the dentition mapper 314 to identify various geometries of the patient's dentition as captured by the corresponding impression.

At operation 420, the mappings of the 3D models are analyzed to identify any anomalous portions of the patient's dentition in the 3D models. For example, in various embodiments, the dentition mapper 314 may identify the anomalous or incomplete portions (e.g., incomplete sides, teeth, or other parts of the impression) of the patient's dental arch in the corresponding mapping of the 3D model, or may be provided with quality review data from a technician indicative of whether the corresponding 3D model includes an incomplete impression of the patient's dental arch. For example, in some embodiments, the mapping of the 3D model may include a mapping of the geometry of the patient's teeth (e.g., from a tip of the tooth to the gums) and a mapping of the geometry of the patient's gingival line. In this case, in some embodiments, the dentition mapper 314 may identify an anomalous portion of the patient's dentition in the 3D model, for example, where the 3D model indicates a mapping of the tip of a particular tooth without a corresponding mapping of a portion of the gingival line for the particular tooth. This situation may occur, for example, where a dental tray was not correctly aligned with a dental arch, or pressure was not evenly applied around the dental tray.

Thus at operation 425, any 3D model mappings analyzed at operation 420 that do not include any anomalous portions are identified. For example, in some embodiments, the dentition mapper 314 may determine if any of the analyzed mappings include a complete impression of the region of the patient's dentition without any anomalous regions therein. If so (e.g., YES), then that particular impression may be identified as a potentially complete impression at block 430, and the method may end. In this case, that particular impression may be used as a suitable complete impression for the region of the patient's dentition, and impressions for another region of the patient's dentition may be analyzed according to the method 400.

If each of the 3D models includes at least one anomalous portion at operation 425 (e.g., NO), then the anomalous portions of the 3D models are compared at operation 435. For example, in some embodiments, the image comparator 316 may compare the mappings of each of the 3D models to determine if the 3D models have any overlapping anomalous portions. In some embodiments, overlapping anomalous portions in two corresponding 3D models may indicate that the two corresponding impressions are not suitable candidates to be merged for generating a full impression. In some embodiments, if none of the anomalous portions of the two corresponding 3D models overlap, then this may indicate that the two corresponding 3D models may be suitable candidates to be merged to generate the full impression.

Accordingly, at operation 440, if the image comparator 316 determines that at least some of the anomalous portions of the 3D models overlap (e.g., YES), then a notification is sent to the patient and the method may end. For example, in some embodiments, the notification manager 320 may send a tailored impression technique suggestion to the patient in order to improve on subsequent impressions. In some embodiments, the notification manager 320 may cause a retake kit to be delivered to the patient in addition to the notification. In some embodiments, the retake kit may be tailored to include an impression kit for retaking only an impression for a region of the patient's dentition that did not result in a suitable impression as determined according to various embodiments of the present disclosure.

If the image comparator 316 determines at operation 440 that the anomalous portions of the 3D models do not overlap (e.g., NO), the 3D models may be merged at operation 450 to generate a suitable merged 3D model of the impressions and the method may end. For example, in some embodiments, the merge manager 318 may generate the suitable merged 3D model using one or more merge strategies. For example, in some embodiments, the merge manager 318 may select geometry from either of the 3D models using the merge strategy, and replace geometry in one 3D model with selected geometry from another 3D model, such that the resulting merged 3D model includes geometry from each of the two 3D models of the impressions. In various embodiments, the merge manager 318 may then use the merged 3D model to generate the suitable 3D model (e.g., the suitable dentition scan) for the corresponding region of the patient's dentition, or the merged 3D model may be provided to a technician for further review.

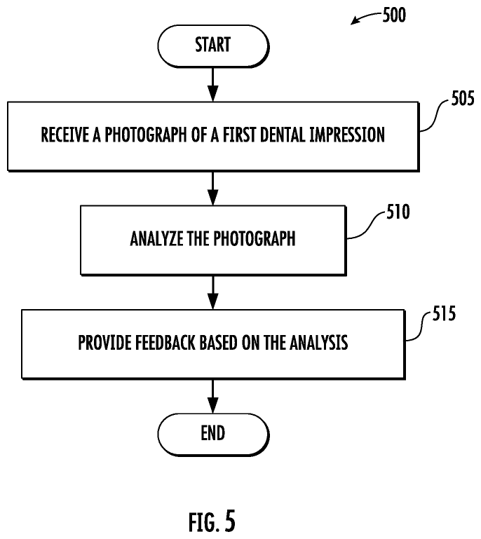

FIG. 5 is a flow diagram of a method for analyzing photographs of dental impressions to provide feedback in real-time or near real-time, according to some embodiments. The functionalities of the method 500 may be implemented using, or performed by, the components detailed herein in connection with FIGS. 1 and 3. In brief overview, the method 500 of FIG. 5 may be used, for example, to analyze photographs of a first impression from an impression kit to provide feedback in real-time or near real-time prior to a second impression from the same impression kit being taken (or prior to returning the impressions to the manufacturer of the intraoral devices), such that issues with impression techniques can be improved when taking the second impression.

Referring to FIG. 5, the method 500 starts, and at operation 505, a photograph (e.g., a 2D image or 3D image) of a first dental impression is received. For example, in some embodiments, the first impression may be taken by the patient using an at-home dental impression kit. In some embodiments, the at-home dental impression kit may include a main dental impression kit to capture an impression of a dental arch (e.g., a mandibular arch or a maxillary arch) of the patient's dentition. In some embodiments, the at-home dental impression kit may include a redundant impression kit to capture a redundant impression of the dental arch. In some embodiments, the first dental impression kit may be one of the main dental impression kit or the redundant impression kit, but may be taken prior to the other one of the main dental impression kit and the redundant impression kit being taken. In some embodiments, the photograph of the first dental impression kit may be received prior to the other one of the main dental impression kit and the redundant impression kit being taken.

At operation 510, the photograph of the first dental impression is analyzed. For example, in some embodiments, various features of the patient's dentition is mapped in the photograph of the first dental impression. For example, in some embodiments, the dentition mapper 314 may identify the teeth and gingiva (e.g., gum) portions of the first dental impression shown in the photograph using any suitable identification algorithm. In some embodiments, the mapping of the patient's dentition in the photograph may enable the dentition mapper 314 to identify various geometries of the patient's dentition as captured by the first impression. In some embodiments, the dentition mapper 314 may analyze the mapping of the patient's dentition in the photograph to identify any anomalous portions in the first impression. For example, in various embodiments, the dentition mapper 314 may identify the anomalous or incomplete portions (e.g., incomplete sides, teeth, or other parts of the impression) of the patient's dental arch in the photograph of the first impression, or may be provided with quality review data from a technician indicative of whether the photograph of the first impression depicts an incomplete impression of the patient's dental arch.

At operation 515, feedback is provided based on the analysis at operation 510. For example, in some embodiments, if the dentition mapper 314 identifies any deficiencies in the photograph of the first dental impression, the notification manager 320 may provide feedback (e.g., via a notification, alert, email, text message, video message, video chat, or the like) in real-time or near real-time with instructions on how to improve an impression technique when taking the other impression from among the main impression kit and the redundant impression kit (e.g., a second impression). Accordingly, subsequent impression may be improved prior to returning the impression to the manufacturer of the intraoral devices, such that retake impression kits can be avoided.

In some embodiments, the method 500 includes receiving, by the dental impression review computer system, an image of the second dental impression from the mobile device. The method 500 can also include analyzing, by the dental impression review computer system, the image of the second dental impression. The method can also include determining, by the dental impression review computer system, that the second dental impression does not include the deficiency identified with respect to the first dental impression. The method can also include providing, by the dental impression review computer system, a message to the user indicating that the second dental impression does not include the deficiency identified with respect to the first dental impression. In some embodiments, the method also includes receiving the second dental impression, and determining, either by the dental impression review computer system, another computer system, or by inspection of a technician, that the second dental impression does not include the deficiency identified with respect to the first dental impression.

In some embodiments, a method includes receiving a dental impression kit that a user can use to administer a plurality of dental impressions of teeth of the user, administering a first dental impression of the teeth, capturing a photograph of the first dental impression, providing the photograph of the first dental impression to a dental impression review computer system, and receiving, from the dental impression review computer system, a message indicating that a deficiency has been identified in the first dental impression and how the user can administer a second dental impression to reduce the likelihood of the second dental impression from including the deficiency.

The method can further include administering the second dental impression of the teeth in accordance with the message. The method can further include capturing a photograph of the second dental impression, and providing the photograph of the second dental impression to the dental impression review computer system. The method can further include receiving, from the dental impression review computer system, a message indicating that the second dental impression does not include the deficiency identified with respect to the first dental impression. The method can further include providing the second dental impression of the teeth to an entity associated with the dental impression review computer system. The method can further include receiving a dental aligner from the entity, the dental aligner having been manufactured based on the second dental impression, the dental aligner being specific to the user and configured to reposition a tooth of the user. The method can further include receiving the message less than an hour after providing the photograph of the first dental impression to the dental impression review computer system. The method can further include receiving the message less than a minute after providing the photograph of the first dental impression to the dental impression review computer system.

In some embodiments, each step of the processes and methods disclosed herein can be performed by the same business entity or group of business entities. In some embodiments, each step of the processes and methods can be performed by a single business entity in a single location (e.g. a building, a group of buildings).

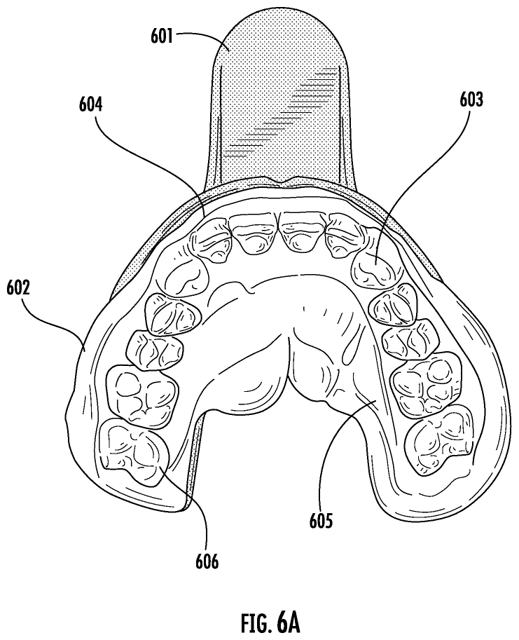

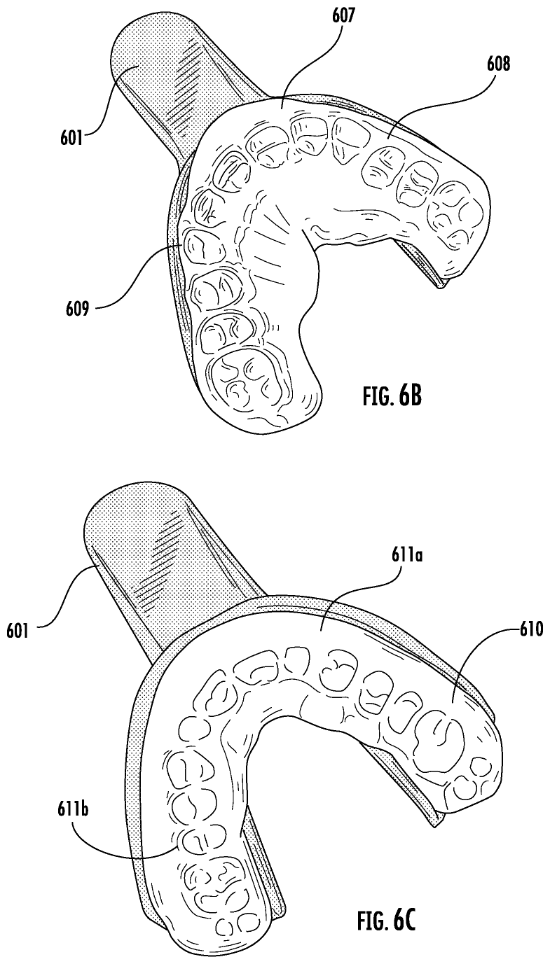

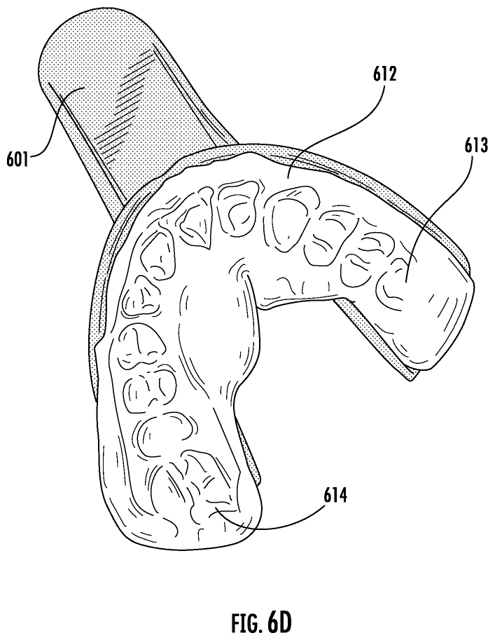

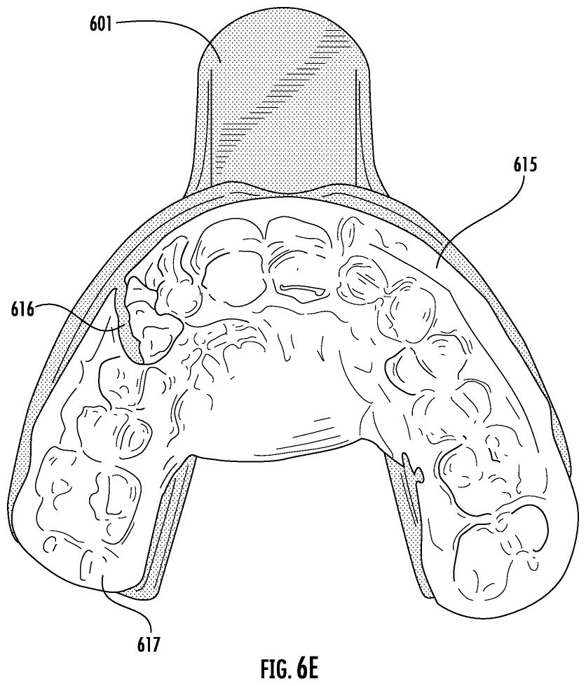

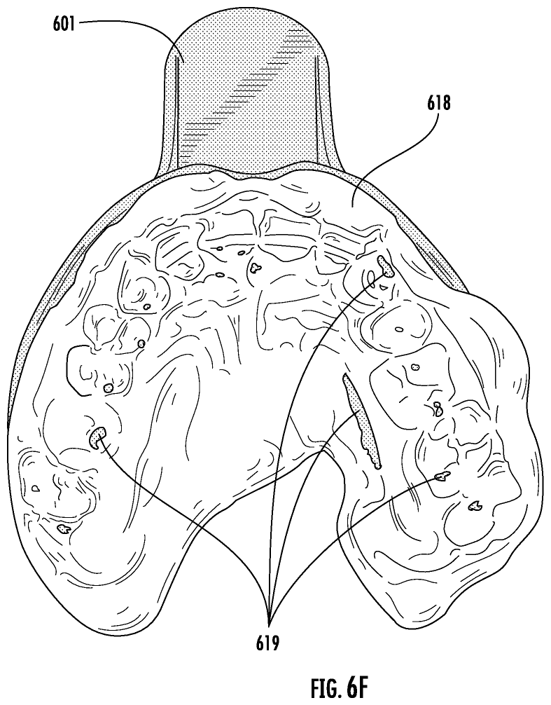

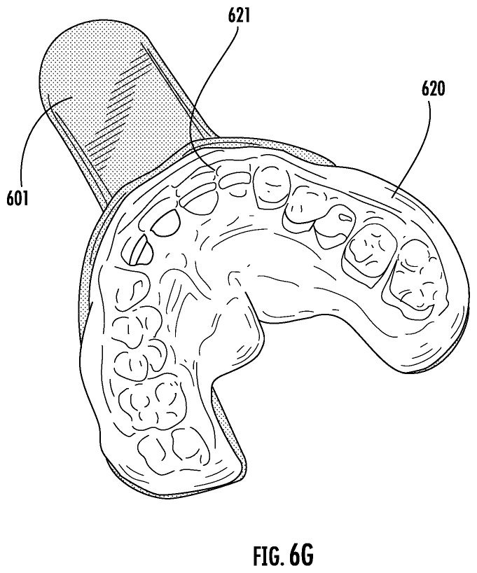

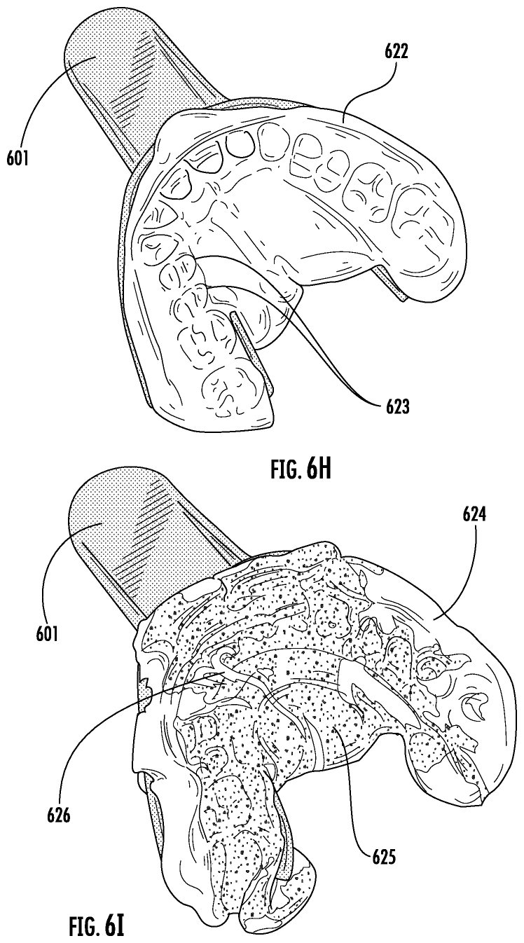

FIGS. 6A-6I show various exemplary embodiments of a dental impression on a dental tray 601. Each embodiment shows a dental tray 601 and a dental impression as a negative impression of the dental arch of a patient FIG. 6A shows an exemplary embodiment where, dental tray 601 contains dental impression 602. In some embodiments, dental impression 602 represents a dental impression that may be acceptable for fabricating a suitable intraoral device for the patient. In some embodiments, features of an acceptable dental impression may include a plurality of single imprints 603, fully captured gum lines 604, fully mixed putty 605, and a plurality of fully captured molars 606.

FIGS. 6B-6I show various exemplary embodiments of dental impressions that may contain at least one deficiency indicative of the dental impression not being suitable for use in manufacturing an intraoral device for a patient. In some embodiments, the deficiency could cause a dental impression to be unacceptable for generating a treatment plan for a patient and fabricating an intraoral device for the patient.

Referring to FIG. 6B, dental tray 601 containing dental impression 607 as a negative impression of the dental arch of a patient is shown as an exemplary embodiment. The dental impression 607 represents an example of a dental impression that may not be acceptable for fabricating a suitable intraoral device for the patient due to a deficiency. A possible deficiency shown on the dental impression 607 is an unevenly positioned impression. The deficiency shown in the dental impression 607 may be due to the dental tray 601 not being seated properly when the dental impression 607 is formed. If a dental impression section (e.g. dental impression section 608) is positioned closer or further from one interior edge of dental tray 601 than another dental impression section (e.g. dental impression section 609), the dental impression 607 is not properly centered in the dental tray 601. Also, the dental tray 601 not being seated properly can cause the dental impression 607 to be improperly centered within dental tray 601. When a dental impression (e.g. dental impression 607) contains a deficiency that may be due to the dental tray 601 not being seated properly, a suggested impression technique to cure this deficiency may be to center the dental tray with the teeth before creating a subsequent impression.

FIG. 6C shows an exemplary embodiment of dental tray 601 containing dental impression 610 as a negative impression of the dental arch of a patient. The dental impression 610 represents an example of a dental impression that may not be acceptable for fabricating a suitable intraoral device for the patient due to a deficiency. A possible deficiency could be that the dental impression 610 is missing at least a portion of the patient's gum line. Impression section 611a of dental impression 610 shows one area where at least a portion of a patient's gum line is expected to be captured but is not captured, whereas impression section 611b shows an area where a portion of the patient's gum line is captured. The deficiency shown in the dental impression 610 may be due to the dental tray 601 not being fully seated when the dental impression 610 is captured. When a dental impression (e.g. dental impression 610) contains a deficiency that may be due to the dental tray 601 not being fully seated, a suggested impression technique to cure this deficiency may be to bite the dental tray 601 or to push the dental tray 601 onto the patient's teeth with a greater force when capturing a subsequent dental impression to ensure that the teeth are positioned deeper within the tray so that the patient's gums are formed in the impression material.

In an exemplary embodiment, shown in FIG. 6D, dental impression 612 as a negative impression of the dental arch of a patient is contained by dental tray 601. The dental impression 612 represents an example of a dental impression that may not be acceptable for fabricating a suitable intraoral device for the patient due to a deficiency. A possible deficiency shown on the dental aligner 612 could be that at least one tooth of the patient is not fully captured. Dental impression 612 contains a right molar impression 613 and a left molar impression 614. The right molar impression 613 is not fully captured and is too shallow at points. The left molar impression 614 is an example of a molar impression that is sufficiently captured. A tooth of one side (e.g. left molar 614) of dental impression 612 being sufficiently captured while a tooth on the other side (e.g. right molar 613) of dental impression 612 is not fully captured may be due to dental tray 601 not being evenly seated when the dental impression 612 is captured. When a dental impression (e.g. dental impression 612) contains a deficiency that may be due to the dental tray 601 not being evenly seated, a suggested impression technique to cure this deficiency may be to apply even pressure on all parts of dental tray 601, including both back molar portions of the dental tray 601, while capturing a subsequent dental impression.

Referring to FIG. 6E, an exemplary embodiment is shown of dental tray 601 containing dental impression 615 as a negative impression of the dental arch of a patient. The dental impression 615 represents an example of a dental impression that may not be acceptable for fabricating a suitable intraoral device due to a deficiency. Dental impression 615 contains tooth impression 616 and molar impression 617. Tooth impression 616 is exemplary of a deficiency that may occur when the tooth corresponding to the tooth impression 616 contacts the interior surface of dental tray 601, which can be seen in FIG. 6E as showing through the dental impression 615 at the location of the tooth impression 616. Molar impression 617 is exemplary of a deficiency that may occur when dental tray 601 does not extend enough to fully capture the tooth corresponding with molar impression 617, which is only partially captured by the dental impression 615, whereas the back molar on the other side of the dental impression 615 is shown to be fully captured by the dental impression 615. These deficiencies may occur when dental tray 601 is incorrectly sized for the patient's dental arch or when the patient's teeth are misaligned with the dental tray 601 when taking the dental impression 615. When a dental impression (e.g. dental impression 615) contains a deficiency that may be due to an incorrectly sized dental tray 601, a suggested technique to cure this deficiency may be to use a larger or smaller dental tray 601 when capturing a subsequent dental impression, or that the user's teeth should instead be scanned by an oral scanning device.

FIG. 6F shows an exemplary embodiment in which dental tray 601 contains dental impression 618 as a negative impression of the dental arch of a patient. The dental impression 618 represents an example of a dental impression that may not be acceptable for fabricating a suitable intraoral device for the patient due to a deficiency. A possible deficiency could be that the putty of dental impression 618 is pierced (e.g., one or more of the patient's teeth push through the putty to the dental tray 601, which in some cases can be seen through the putty once the dental tray 601 is removed from the patient's teeth). The dental impression 618 may become pierced when too much pressure is applied while the dental impression 618 is captured. Various piercings 619 are located on dental impression 618, where the putty has holes. When a dental impression (e.g. dental impression 618) contains a deficiency that may be due to too much pressure being applied to the dental tray 601, a suggested technique to cure this deficiency may be to apply less force to dental tray 601 while a subsequent dental impression is captured.

In an exemplary embodiment, as shown in FIG. 6G, dental impression 620 is a negative impression of the dental arch of a patient that is contained by dental tray 601. The dental impression 620 represents an example of a dental impression that may not be acceptable for fabricating a suitable intraoral device for the patient due to a deficiency. A possible deficiency could be that the dental impression 620 has a dual imprint of one or more teeth or of a gum line. A double impression 621 is shown on the dental impression 620, where a second impression of a single tooth overlaps the first impression of that tooth. Double impressions (e.g. double impression 621) can be caused when the dental tray 601 moves while the dental impression 620 is captured or by the patient inserting the dental tray 601 over their teeth, partially or fully removing the dental tray 601 before the impression cures, and then reinserting the dental tray 601 back over their teeth. When a dental impression (e.g. dental impression 620) contains a deficiency that may be due to the dental tray 601 moving while dental impression 620 is captured or by being reinserted over the patient's teeth, a suggested technique to cure this deficiency may be to ensure that the dental tray 601 does not move or adjust during a subsequent impression after it has been seated on the patient's teeth.

Referring to FIG. 6H, an exemplary embodiment with dental impression 622 as a negative impression of the dental arch contained by dental tray 601 is shown. The dental impression 622 represents an example of a dental impression that may not be acceptable for fabricating a suitable intraoral device for the patient due to a deficiency. A possible deficiency could be that the dental impression 622 has an overly elongated tooth impression or a tooth scraped along the edge of the putty when the dental tray 601 was removed in the processing of capturing dental impression 622. Various scrapes 623 are shown, where the tooth is shown to be incorrectly elongated to not match the user's actual tooth, on the surface of the dental impression 622. These deficiencies could happen when the dental tray 601 is removed too early, and the putty is not fully set, while the dental impression 622 is formed. When a dental impression (e.g. dental impression 622) contains a deficiency that may be due to the dental tray 601 being removed too early while the dental impression 622 is being formed, a suggested technique to cure this deficiency may be to leave the dental tray 601 in the mouth for a longer duration of time when taking a subsequent dental impression so that the putty of dental impression 622 fully sets.

FIG. 6I shows an exemplary embodiment of dental impression 624 as a negative impression of the dental arch contained by dental tray 601. The dental impression 624 represents an example of a dental impression that may not be acceptable for fabricating a suitable intraoral device for the patient due to a deficiency. A possible deficiency could be that the dental impression 624 does not have properly mixed putty. The dental impression 624 has a first distinct color 624 and a second distinct color 625, indicating that one or more putties being different colors did not completely mix with one another to form a third color. This may be due to the putty not being mixed long enough, or thoroughly enough to become fully mixed and activated. Another potential indication that the putty is not fully mixed is a swirl 626 between the distinct first distinct color 624 and the second distinct color 625. When a dental impression (e.g. dental impression 624) contains a deficiency that may be due to the putty mixture that the dental impression 624 is made of, a suggested technique to cure this deficiency when taking a subsequent dental impression may be to mix the putty for a longer duration of time or by mixing the putty more thoroughly before capturing the subsequent dental impression.

The various deficiencies, causes of deficiencies, and techniques to cure deficiencies identified are not intended to be limiting. Deficiencies not explicitly listed are possible that would result in a dental impression being unfit for fabricating a suitable intraoral device for the patient. A cause of a deficiency identified may contribute to more than one deficiency, and a deficiency may have more than one cause. Techniques to overcome deficiencies may exist that are not listed or described, but nonetheless contemplated to be part of the present disclosure. One deficiency may have multiple techniques to cure the deficiency, and one technique to cure a deficiency may be able to cure multiple deficiencies. Furthermore, for all of the deficiencies described, a suggestion to cure the deficiency may be for the user's teeth to be scanned by an oral scanning device.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be X, Y, or Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, flash memory, hard disk storage) for storing data and/or computer code for completing or facilitating the various processes, layers and circuits described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems and methods shown in the various exemplary embodiments are illustrative only. Additionally, any element disclosed in one embodiment may be incorporated or utilized with any other embodiment disclosed herein.

1. A method for analyzing a dental impression, comprising:
receiving, by a dental impression review computer system, an image of a first dental impression administered by a user of the user's teeth;
analyzing, by the dental impression review computer system, the image of the first dental impression by mapping negative actual features of a dentition corresponding to the first dental impression and comparing the negative actual features of the dentition to a negative expected feature of the dentition; and
providing, by the dental impression review computer system, feedback to the user based on the analysis.

2. The method of claim 1, further comprising:
receiving, by the dental impression review computer system after providing the feedback to the user, an image of a second dental impression administered by the user,
wherein the image of the first dental impression is a photograph.

3. The method of claim 1, wherein the feedback is provided to the user in real-time and includes a suggestion for improving an impression technique of the user for taking a second dental impression.

4. The method of claim 3, wherein the analysis of the image includes identifying a deficiency with the first dental impression from the image and wherein the suggestion for improving the impression technique is tailored based on the identified deficiency.

5. The method of claim 1, wherein the first dental impression is taken by the user at the user's home or other location not associated with a dental office or orthodontic office.

6. A dental impression review computer system, comprising:
a processor and memory coupled to the processor, the memory storing instructions that, when executed by the processor, are configured to cause the processor to:
receive an image of a first dental impression administered by a user of the user's teeth;
analyze the image of the first dental impression by mapping negative actual features of a dentition corresponding to the first dental impression and comparing the negative actual features of the dentition to a negative expected feature of the dentition; and
provide feedback to the user based on the analysis.

7. The system of claim 6, further comprising:
receiving, by the dental impression review computer system after providing the feedback to the user, an image of a second dental impression administered by the user,
wherein the image of the first dental impression is a photograph.

8. The system of claim 6, wherein the feedback is provided to the user in real-time and includes a suggestion for improving an impression technique of the user for taking a second dental impression.

9. The system of claim 8, wherein the analysis of the image includes identifying a deficiency with the first dental impression from the image and wherein the suggestion for improving the impression technique is tailored based on the identified deficiency.

10. A method for analyzing a dental impression, comprising:
receiving, by a dental impression review computer system, an image of a first dental impression from a mobile device associated with a first user, the first dental impression being of a dental impression administered by the first user;
analyzing, by the dental impression review computer system, the image of the first dental impression by mapping negative actual features of a first dentition corresponding to the first dental impression and comparing the negative actual features of the first dentition to a negative actual feature of a second dentition corresponding to a second dental impression administered by a second user;
identifying, by the dental impression review computer system, a deficiency with the first dental impression from the image based on the analysis; and
providing, by the dental impression review computer system, feedback based on the deficiency to the mobile device associated with the first user, the feedback indicating how the first user can administer a third dental impression to reduce the likelihood of the third dental impression from including the deficiency.

11. The method of claim 10, further comprising:
receiving, by the dental impression review computer system, an image of the third dental impression from the mobile device;
analyzing, by the dental impression review computer system, the image of the third dental impression;
determining, by the dental impression review computer system, that the third dental impression does not include the deficiency identified with respect to the first dental impression; and
providing, by the dental impression review computer system, a message to the first user indicating that the third dental impression does not include the deficiency identified with respect to the first dental impression.

12. The method of claim 10, further comprising:
receiving the third dental impression; and
determining that the third dental impression does not include the deficiency identified with respect to the first dental impression.

13. The method of claim 12, wherein at least one of the first dental impression or the third dental impression is taken at the first user's home or other location not associated with a dental office or orthodontic office.

14. The method of claim 10, wherein the image of the first dental impression is a 2D image or a 3D image.

15. The method of claim 10, wherein the feedback based on the deficiency is provided in real-time.

16. The method of claim 10, wherein the deficiency is an incomplete gum line, and wherein analyzing the image of the first dental impression comprises checking for a complete gum line.

17. The method of claim 16, wherein when the deficiency of an incomplete gum line is identified, the feedback comprises instructing the first user to push a dental tray containing an impression material onto the first user's teeth with greater force when administering the third dental impression.

18. The method of claim 10, wherein the deficiency is a piercing of an impression material of the first dental impression, and wherein analyzing the image of the first dental impression comprises checking for the piercing.

19. The method of claim 18, wherein when the deficiency of the piercing is identified, the feedback comprises instructing the first user to apply less force to a dental tray containing an impression material for the third dental impression when the first user's teeth are inserted into the impression material.

20. The method of claim 10, wherein the deficiency is unevenly positioned teeth in an impression material of the first dental impression, and wherein analyzing the image of the first dental impression comprises checking for the teeth to be evenly positioned in the impression material of the first dental impression.

21. The method of claim 20, wherein when the deficiency of unevenly positioned teeth is identified, the feedback comprises instructing the first user to center a dental tray containing impression material for the third dental impression over the first user's teeth when administering the third dental impression.

22. The method of claim 21, wherein the feedback is provided to the mobile device associated with the first user by at least one of a notification, an alert, an email, a text message, a video message, a video chat, or a phone call.

23. A method comprising:
receiving a dental impression kit that a first user can use to administer a plurality of dental impressions of teeth of the first user;
administering a first dental impression of the teeth of the first user;
capturing a photograph of the first dental impression;
providing the photograph of the first dental impression to a dental impression review computer system; and
receiving, from the dental impression review computer system, a message indicating that a deficiency has been identified in the first dental impression and how the first user can administer a third dental impression to reduce the likelihood of the third dental impression from including the deficiency;
wherein the deficiency is identified by the dental impression review computer system by mapping negative actual features of a first dentition corresponding to the first dental impression and comparing the negative actual features of the first dentition to a negative actual feature of a second dentition corresponding to a second dental impression administered by a second user.

24. The method of claim 23, further comprising administering the third dental impression of the teeth in accordance with the message.

25. The method of claim 24, further comprising:
capturing a photograph of the third dental impression; and
providing the photograph of the third dental impression to the dental impression review computer system.

26. The method of claim 25, further comprising receiving, from the dental impression review computer system, a message indicating that the third dental impression does not include the deficiency identified with respect to the first dental impression.

27. The method of claim 24, further comprising providing the third dental impression of the teeth to an entity associated with the dental impression review computer system.

28. The method of claim 27, further comprising receiving a dental aligner from the entity, the dental aligner having been manufactured based on the third dental impression, the dental aligner being specific to the first user and configured to reposition a tooth of the first user.

29. The method of claim 23, wherein the message is received less than an hour after providing the photograph of the first dental impression to the dental impression review computer system.

30. The method of claim 23, wherein the message is received less than a minute after providing the photograph of the first dental impression to the dental impression review computer system.
